(19) United States
(12) Patent Application Publication
(10) Pub. No.: US 2016/0353332 A1
(43) Pub. Date: Dec. 1, 2016

(54) SERVER AND METHOD FOR VIDEO CALL HANDOVER ADAPTABILITY

(71) Applicants: NANNING FUGUI PRECISION INDUSTRIAL CO., LTD., Nanning (CN); HON HAI PRECISION INDUSTRY CO., LTD., New Taipei (TW)

(72) Inventor: QIONG XIAO, Shenzhen (CN)

(21) Appl. No.: 15/139,338

(22) Filed: Apr. 27, 2016

(30) Foreign Application Priority Data
May 27, 2015 (CN) 201510276754.4

(51) Int. Cl. H04W 36/00; H04L 29/06

(52) U.S. Cl. CPC H04W 36/0022; H04L 65/1016; H04L 65/1069

(57) ABSTRACT

In a method for video call handover between exclusive circuit switching (CS) and packet switching (PS) networks, a first CS video call parameter of a user equipment is acquired after the user equipment establishes a video call within a PS domain. A second CS video call parameter of a mobile switching center (MSC) server is read from an information table. The first CS video call parameter is compared with the second CS video call parameter to discover any common parameter. Such a common parameter is transmitted to the MSC server when the video call of the user equipment is transferred from the PS domain to a CS domain. A confirmed parameter is received from the MSC server, and transmitted to the user equipment to re-establish the video call within the CS domain.

### CROSS-REFERENCE TO RELATED APPLICATIONS

This application claims priority to Chinese Patent Application No. 201510276754.4 filed on May 27, 2015, the contents of which are incorporated by reference herein.

### FIELD

The subject matter herein generally relates to an internet protocol (IP) multimedia subsystem (IMS) technology.

### BACKGROUND

Voice over long-term evolution (Voice over LTE or VoLTE) is a technology specification that defines the standards and procedures for delivering voice communication and data over 4G LTE networks. It is one method for creating, provisioning, and managing high-speed voice, video, and messaging services on a 4G wireless network for mobile and portable devices. However, before the 4G network architecture, third generation (3G) networks and 4G networks co-existed for a long period of time, so that signal switches between 3G and 4G networks were commonplace. In other words, single radio video call continuity for 3G-circuit-switched network (vSRVCC) provides support for video call handover from E-UTRAN to UTRAN-circuit switched network for service continuity when the video call is anchored in the IMS and a user equipment (UE) is capable of transmitting/receiving on only one of those access networks at a given time.

A solution for transferring a video call between access networks enables a UE to pre-negotiate first to a circuit switching (CS) video call parameter with a mobile switching center (MSC) server in a packet switching (PS) domain. When the UE video call has been transferred from the PS domain to a CS domain, the UE establishes a video call within the CS domain according to the pre-negotiated CS video call parameter. However, if the pre-negotiation is required before the video call transfer, it is resource-wasting and may increase latency of the video call transfer, which results in bad user experience.

### BRIEF DESCRIPTION OF THE DRAWINGS

Implementations of the present technology will now be described, by way of example only, with reference to the attached figures, wherein:

FIG. 1 illustrates a block diagram of an embodiment of a service centralization and continuity (SCC) application server including a handover system.

FIG. 2 illustrates a flowchart of an embodiment of a method for video call handover.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

References to “an” or “one” embodiment in this disclosure are not necessarily to the same embodiment, and such references mean “at least one.”

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series, and the like.

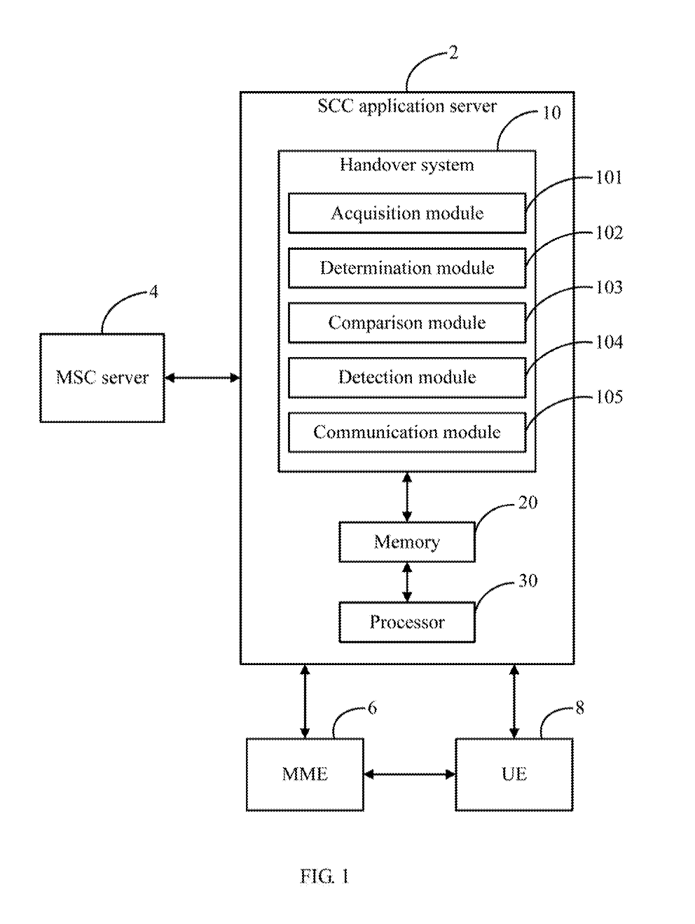

FIG. 1 illustrates a block diagram of an embodiment of a service centralization and continuity application server (SCC application server 2). In the embodiment, the SCC application server 2 includes a handover system 10, a memory 20, and a processor 30. The SCC application server 2 is electronically connected to multiple mobile switching center servers (MSC servers 4), multiple mobility management entities (MMES 6), and multiple user equipments (UEs 8).

The handover system 10 includes one or more function modules. The one or more function modules can include computerized code in the form of one or more programs that are stored in the memory 20, and executed by the processor 30 to provide functions of the handover system 10. The memory 20 can be a dedicated memory, such as an EEPROM or a flash memory.

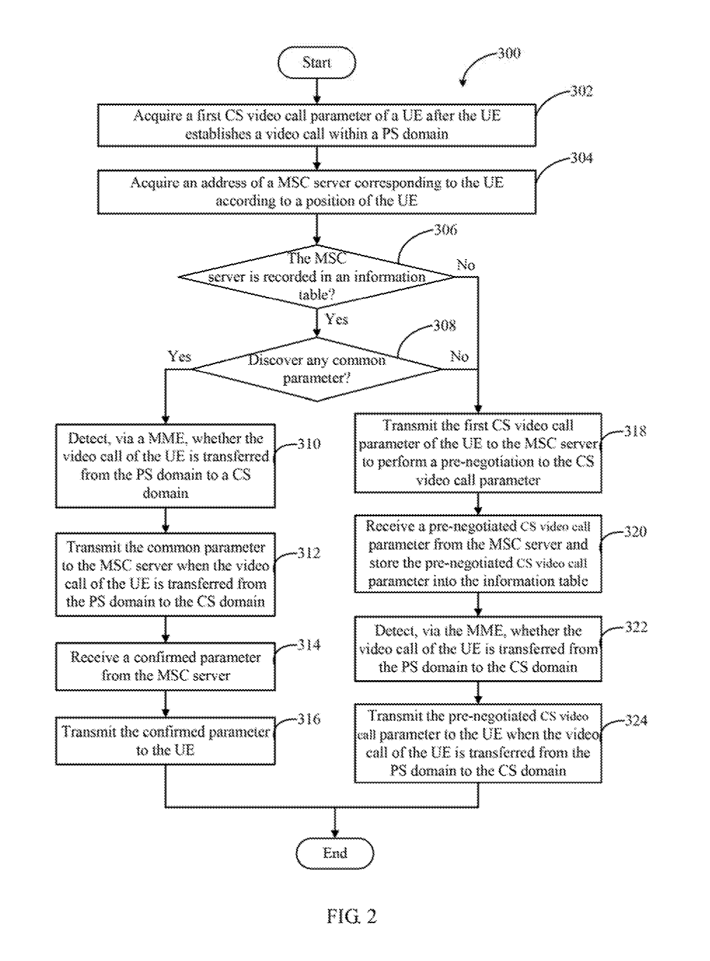

In an embodiment, the handover system 10 includes an acquisition module 101, a determination module 102, a comparison module 103, a detection module 104, and a communication module 105. Descriptions of the functions of the modules 101˜105 are given with reference to FIG. 2.

Referring to FIG. 2, a flowchart is presented in accordance with an example embodiment of a method 300 for video call handover. The method 300 is provided by way of example, as there are a variety of ways to carry out the method. The method 300 described below can be carried out using the configurations illustrated in FIG. 1, for example, and various elements of these figures are referenced in explaining the method 300. Each block shown in FIG. 2 represents one or more processes, methods, or subroutines carried out in the exemplary method 300. Additionally, the illustrated order of blocks is by example only and the order of the blocks can change. The method 300 can begin at block 302.

At block 302, the acquisition module 101 acquires a first circuit switching (CS) video call parameter of a UE 8 after the UE 8 establishes a video call within a packet switching (PS) domain. In the embodiment, the UE 8 establishes the video call using a standard protocol, for example, the 3G-324M standard, for video telephony in 3G mobile networks. The CS video call parameters, for example, are video codec parameters or audio codec parameters, which comply with the 3G-324M standard.

At block 304, the acquisition module 101 acquires an address of a MSC server 4 corresponding to the UE 8 according to a position of the UE 8. In the embodiment, the acquisition module 101 acquires the position of the UE 8 according to a request message sent from the UE 8, and then acquires the address of the MSC server 4 at the area where the UE 8 is located.

At block 306, the determination module 102 searches for the address of the MSC server 4 in an information table to determine whether the MSC server 4 is recorded. In the embodiment, the information table, which records CS video call parameters corresponding to each MSC server 4, is stored in the memory 20. The CS video call parameters corresponding to each MSC server 4 are the outputs of pre-negotiations between the multiple MSC servers 4 and the multiple UEs 8, and can be directly used to establish the video call. If the MSC server 4 is recorded in the information table, the method 300 proceeds to block 308. If not, the process goes to blocks 318˜324.

At block 308, the comparison module 103 reads a second CS video call parameter of the MSC server 4 from the information table, and compares the first CS video call parameter with the second CS video call parameter to discover any common parameter. In the embodiment, if the first CS video call parameter is the same as the second CS video call parameter, the first or second CS video call parameter is regarded as the common parameter. If a common parameter is discovered, the method 300 proceeds to blocks 310˜316. If not, the process proceeds to blocks 318˜324.

At block 310, the detection module 104 detects, via the MME 6, whether the video call of the UE 8 is transferred from the PS domain to a CS domain.

At block 312, the communication module 105 transmits the common parameter to the MSC server 4 when the video call of the UE 8 is transferred from the PS domain to the CS domain.

At block 314, the communication module 105 receives a confirmed parameter from the MSC server 4. In the embodiment, if the confirmed parameter is different from the common parameter, the communication module 10 updates the information table according to the confirmed parameter. In detail, the communication module 10 replaces the second CS video call parameter of the MSC server 4 in the information table with the confirmed parameter.

At block 316, the communication module 105 transmits the confirmed parameter to the UE 8. Then the UE 8 re-establishes the video call within the CS domain according to the confirmed parameter.

At block 318, the communication module 105 transmits the first CS video call parameter of the UE 8 to the MSC server 4 to perform a pre-negotiation to the CS video call parameter.

At block 320, the communication module 105 receives a pre-negotiated CS video call parameter from the MSC server 4 and stores the pre-negotiated CS video call parameter into the information table.

At block 322, the detection module 104 detects, via the MME 6, whether the video call of the UE 8 is transferred from the PS domain to the CS domain.

At block 324, the communication module 105 transmits the pre-negotiated CS video call parameter to the UE 8 when the video call of the UE 8 is transferred from the PS domain to the CS domain. Then the UE 8 re-establishes the video call within the CS domain according to the pre-negotiated CS video call parameter.

The embodiments shown and described above are only examples. Many details are often found in the art such as the other features of a mobile device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A computer-implemented method, executable by a processor of a service centralization and continuity (SCC) application server, the method comprising:
acquiring a first circuit switching (CS) video call parameter of an user equipment (UE) after the UE establishes a video call within a packet switching (PS) domain;
acquiring an address of a mobile switching center (MSC) server corresponding to the UE according to a position of the UE;
searching for the address of the MSC server in an information table to determine whether the MSC server is recorded;
reading a second CS video call parameter of the MSC server from the information table, in response to that the MSC server is recorded in the information table;
comparing the first CS video call parameter with the second CS video call parameter to discover any common parameter;
when a common parameter is discovered, detecting, via a mobility management entity (MME), whether the video call of the UE is transferred from the PS domain to a CS domain;
transmitting the common parameter to the MSC server in response to that the video call of the UE is transferred from the PS domain to the CS domain;
receiving a confirmed parameter from the MSC server; and
transmitting the confirmed parameter to the UE to re-establish the video call within the CS domain.

2. The method as claimed in claim 1, further comprising:
transmitting the first CS video call parameter of the UE to the MSC server to perform a pre-negotiation to the CS video call parameter, in response to that the MSC server is not recorded in the information table or no common parameter is discovered;
receiving a pre-negotiated CS video call parameter from the MSC server;
storing the pre-negotiated CS video call parameter into the information table;
detecting, via the MME, whether the video call of the UE is transferred from the PS domain to the CS domain; and
transmitting the pre-negotiated CS video call parameter to the UE to re-establish the video call within the CS domain, in response to that the video call of the UE is transferred from the PS domain to the CS domain.

3. The method as claimed in claim 1, wherein the information table records CS video call parameters corresponding to each MSC server, wherein the CS video call parameters are outputs of pre-negotiations between multiple MSC servers and multiple UEs.

4. The method as claimed in claim 3, further comprising:
updating the information table according to the confirmed parameter in response to that the confirmed parameter is different from the common parameter.

5. The method as claimed in claim 1, wherein the UE establishes the video call using a 3G-324M standard, and the first and second CS video call parameters comply with the 3G-324M standard.

6. A non-transitory storage medium, storing a set of instructions, the set of instructions being executed by a processor of a service centralization and continuity (SCC) application server, to perform a method comprising:
acquiring a first circuit switching (CS) video call parameter of an user equipment (UE) after the UE establishes a video call within a packet switching (PS) domain;
acquiring an address of a mobile switching center (MSC) server corresponding to the UE according to a position of the UE;
searching for the address of the MSC server in an information table to determine whether the MSC server is recorded;
reading a second CS video call parameter of the MSC server from the information table, in response to that the MSC server is recorded in the information table;
comparing the first CS video call parameter with the second CS video call parameter to discover any common parameter;
when a common parameter is discovered, detecting, via a mobility management entity (MME), whether the video call of the UE is transferred from the PS domain to a CS domain;
transmitting the common parameter to the MSC server in response to that the video call of the UE is transferred from the PS domain to the CS domain;
receiving a confirmed parameter from the MSC server; and
transmitting the confirmed parameter to the UE to re-establish the video call within the CS domain.

7. The non-transitory storage medium as claimed in claim 6, wherein the method further comprises:
transmitting the first CS video call parameter of the UE to the MSC server to perform a pre-negotiation to the CS video call parameter, in response to that the MSC server is not recorded in the information table or no common parameter is discovered;
receiving a pre-negotiated CS video call parameter from the MSC server;
storing the pre-negotiated CS video call parameter into the information table;
detecting, via the MME, whether the video call of the UE is transferred from the PS domain to the CS domain; and
transmitting the pre-negotiated CS video call parameter to the UE to re-establish the video call within the CS domain, in response to that the video call of the UE is transferred from the PS domain to the CS domain.

8. The non-transitory storage medium as claimed in claim 6, wherein the information table records CS video call parameters corresponding to each MSC server, wherein the CS video call parameters are outputs of pre-negotiations between multiple MSC servers and multiple UEs.

9. The non-transitory storage medium as claimed in claim 8, wherein the method further comprises:
updating the information table according to the confirmed parameter in response to that the confirmed parameter is different from the common parameter.

10. The non-transitory storage medium as claimed in claim 6, wherein the UE establishes the video call using a 3G-324M standard, and the first and second CS video call parameters comply with the 3G-324M standard.

11. A server, the server comprising:
a processor;
memory storing instructions,
wherein the instructions are executed on the processor to cause the processor to:
acquire a first circuit switching (CS) video call parameter of an user equipment (UE) after the UE establishes a video call within a packet switching (PS) domain;
acquire an address of a mobile switching center (MSC) server corresponding to the UE according to a position of the UE;
search for the address of the MSC server in an information table to determine whether the MSC server is recorded;
read a second CS video call parameter of the MSC server from the information table, in response to that the MSC server is recorded in the information table;
compare the first CS video call parameter with the second CS video call parameter to discover any common parameter;
when a common parameter is discovered, detect, via a mobility management entity (MME), whether the video call of the UE is transferred from the PS domain to a CS domain;
transmit the common parameter to the MSC server in response to that the video call of the UE is transferred from the PS domain to the CS domain;
receive a confirmed parameter from the MSC server; and
transmit the confirmed parameter to the UE to re-establish the video call within the CS domain.

12. The server as claimed in claim 11, wherein the instructions executed on the processor further causes the processor to:
transmit the first CS video call parameter of the UE to the MSC server to perform a pre-negotiation to the CS video call parameter, in response to that the MSC server is not recorded in the information table or no common parameter is discovered;
receive a pre-negotiated CS video call parameter from the MSC server;
store the pre-negotiated CS video call parameter into the information table;
detect, via the MME, whether the video call of the UE is transferred from the PS domain to the CS domain; and
transmit the pre-negotiated CS video call parameter to the UE to re-establish the video call within the CS domain, in response to that the video call of the UE is transferred from the PS domain to the CS domain.

13. The server as claimed in claim 11, wherein the information table records CS video call parameters corresponding to each MSC server, wherein the CS video call parameters are outputs of pre-negotiations between multiple MSC servers and multiple UEs.

14. The server as claimed in claim 13, wherein the instructions executed on the processor further causes the processor to:
update the information table according to the confirmed parameter in response to that the confirmed parameter is different from the common parameter.

15. The server as claimed in claim 11, wherein the first and second CS video call parameters comply with a 3G-324M standard.
